(19) United States
(12) Patent Application Publication
(10) Pub. No.: US 2020/0226459 A1
(43) Pub. Date: Jul. 16, 2020

(54) ADVERSARIAL INPUT IDENTIFICATION USING REDUCED PRECISION DEEP NEURAL NETWORKS

(71) Applicant: International Business Machines Corporation, Armonk, NY (US)

(72) Inventors: Chia-Yu Chen, Westchester, NY (US); Pin-Yu Chen, Cambridge, MA (US); Pierce I-Jen Chuang, Briarcliff Manor, NY (US); Richard Chen, Mount Kisco, NY (US); Jungwook Choi, Chappaqua, NY (US); Kailash Gopalakrishnan, San Jose, CA (US)

(73) Assignee: International Business Machines Corporation, Armonk, NY (US)

(21) Appl. No.: 16/245,463

(22) Filed: Jan. 11, 2019

(51) Int. Cl. G06N 3/08; G06N 3/04; G06N 20/20

(52) U.S. Cl. CPC G06N 3/08; G06N 20/20; G06N 3/0454

(57) ABSTRACT

A processor receives input data and provides the input data to a first neural network including a first neural network model. The first neural network model has a first numerical precision level. A first feature vector is generated from the input data using the first neural network. The input data is provided to a second neural network including a second neural network model. The second neural network model has a second numerical precision level different from the first numerical precession level. A second feature vector is generated from the input data using the second neural network. A difference metric is computed between the first feature vector and the second feature vector. The difference metric is indicative of whether the input data includes adversarial data.

### TECHNICAL FIELD

The present invention relates generally to a method, system, and computer program product for identifying adversarial inputs for deep neural networks. More particularly, the present invention relates to a method, system, and computer program product for adversarial input identification using reduced precision deep neural networks.

### BACKGROUND

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior. A feedforward neural network is an artificial neural network where connections between the units do not form a cycle.

A deep neural network (DNN) is an artificial neural network (ANN) with multiple hidden layers of units between the input and output layers. Similar to shallow ANNs, DNNs can model complex non-linear relationships. DNN architectures, e.g., for object detection and parsing, generate compositional models where the object is expressed as a layered composition of image primitives. The extra layers enable composition of features from lower layers, giving the potential of modeling complex data with fewer units than a similarly performing shallow network. DNNs are typically designed as feedforward networks. DNNs are often used for image classification tasks for computer vision in which an object represented in an image is identified and classified.

### SUMMARY

The illustrative embodiments provide a method, system, and computer program product. An embodiment of a method includes receiving, by a processor, input data, and providing the input data to a first neural network including a first neural network model. In the embodiment, the first neural network model has a first numerical precision level. The embodiment further includes generating a first feature vector from the input data using the first neural network, and providing the input data to a second neural network including a second neural network model. In the embodiment, the second neural network model has a second numerical precision level different from the first numerical precession level. The embodiment further includes generating a second feature vector from the input data using the second neural network. The embodiment further includes computing a difference metric between the first feature vector and the second feature vector. In the embodiment, the difference metric is indicative of whether the input data includes adversarial data.

Another embodiment further includes comparing the difference metric to a predetermined threshold value.

Another embodiment further includes determining that the difference metric exceeds the predetermined threshold value, and determining that the input data includes the adversarial data responsive to the determining that the difference metric exceeds the predetermined threshold value. Another embodiment further includes discarding the input data.

Another embodiment further includes determining that the difference metric does not exceed the predetermined threshold value, and determining a classification of the input data responsive to the determining that the difference metric does not exceed the predetermined threshold value.

In another embodiment, the first numerical precision level is greater than the second numerical precision level. In another embodiment, the first numerical precision level is a full numerical precision level.

In another embodiment, the first neural network model is a published neural network model with a known numerical precision level. In another embodiment, the second neural network model is a reduced precision neural network model. In another embodiment, the second neural network model is an encrypted neural network model.

In another embodiment, one or more layers of the second neural network model include different numerical precision levels.

In another embodiment, one or more of the first neural network or the second neural network includes a deep neural network (DNN). In another embodiment, the input data includes image data.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for adversarial input identification using reduced precision deep neural networks in accordance with an illustrative embodiment;

FIG. 4 depicts a block diagram of an example sequence for classification of normal non-adversarial data using reduced numerical precision neural networks in accordance with an illustrative embodiment;

FIG. 5, this figure depicts a block diagram of an example architecture for encrypted reduced precision neural network models in accordance with an embodiment;

FIG. 6 depicts a block diagram of an example sequence for identification of adversarial data using reduced numerical precision neural networks in accordance with an illustrative embodiment;

FIG. 7 depicts a block diagram of an example detector/classifier architecture for adversarial input identification using reduced precision deep neural networks in accordance with an illustrative embodiment; and

FIG. 8 depicts a flowchart of an example process for adversarial input identification using reduced precision deep neural networks in accordance with an illustrative embodiment.

### DETAILED DESCRIPTION

The illustrative embodiments described herein are directed to adversarial input identification using reduced precision deep neural networks. One or more embodiments recognize that deep neural networks (DNNs) have achieved success in a variety of applications, such as image classification for computer vision, but are often vulnerable to adversarial inputs. In one or more embodiments, an adversarial input refers to an input to a neural network model that an entity, such as an attacker, has intentionally designed to cause the neural network model to make a mistake in classification or identification of input data such as image data.

In an example, an attacker may begin with an image of an object such as a bus and add small perturbations to the image that have been calculated to cause a neural network to classify the image as a compact car with high confidence. Often, the small perturbations may not be readily detectable by a human observer of the image. Such purposeful attacks to a neural network may lead, for example, to a failure of a computer vision system of an autonomous vehicle to properly identify an obstacle.

Moreover, adversarial inputs may transfer across models such that the same adversarial example is often misclassified by different models. One or more embodiments recognize that traditional approaches to defend against the input of adversarial examples into a neural network are inadequate.

One or more are directed to a hardware-based precision system to filter out or reject adversarial inputs by training one or more encrypted neural network models of different numerical precision and providing each of the one or more encrypted neural networks of different numerical precision with the same input data. In one or more embodiments, numerical precision of neural network refers to a numerical procession of one or more layers of the neural network such as 32-bit floating point, 16-bit floating point, 8-bit floating point, 8-bit integer, 4-bit floating point, 4-bit integer, 2-bit floating point, etc. In one or more embodiments, an encrypted neural network model refers to a neural network model that is hidden within encrypted software and/or encrypted hardware such that the overall precision, precision of each layer, and other neural network model parameters are in an encrypted state and not known to a user providing input data to the neural network.

In one or more embodiments, deep learning training with reduced numerical precision models (e.g., 8-bit or 16-bit numerical precision DNN models) may be implemented to obtain the same or similar accuracy as full precision models (e.g., 32-bit numerical precision DNN models) due to the use of training data and convergence of the DNNs. In addition, reduced numerical precision (or quantized) neural network models are often more robust than full-precision neural network models while also being more computational efficient.

In one or more embodiments, different precision neural networks of the same neural network architecture may produce very different responses to adversarial inputs in whereas for normal (e.g., non-adversarial) input data the same neural network may produce substantially similar responses. In one or more embodiments, the system calculates a difference metric between the responses of each neural network and compares the difference metric to a predetermined threshold value. In one or more embodiments, if the difference metric is less than or equal to the predetermined threshold value, the system determines that the input data does not include adversarial data and classifies the input data based upon the outputs of the neural networks. In one or more embodiments, if the difference metric is greater than the predetermined threshold value, the system identifies the input data as including adversarial data and filters out or discards the input data.

In one or more embodiments, if one or more of the neural networks outputs a plurality of vectors, the system may determine a difference metric based upon comparison of different distributions of feature vectors.

An embodiment can be implemented as a software application. The application implementing an embodiment can be configured as a modification of an existing system or platform, as a separate application that operates in conjunction with an existing system or platform, a standalone application, or some combination thereof.

The illustrative embodiments are described with respect to certain types of tools and platforms, procedures and algorithms, services, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

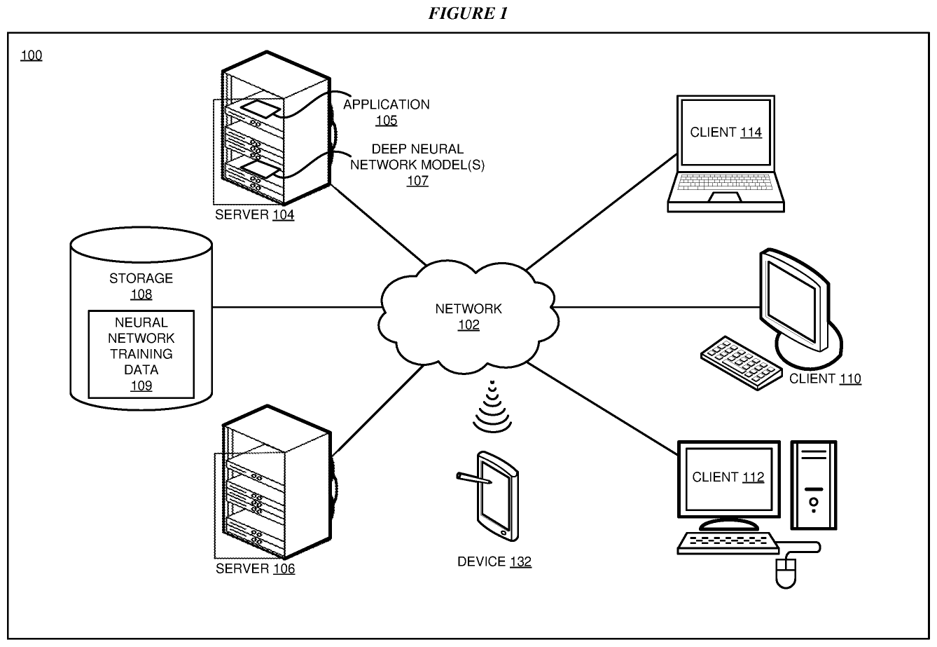

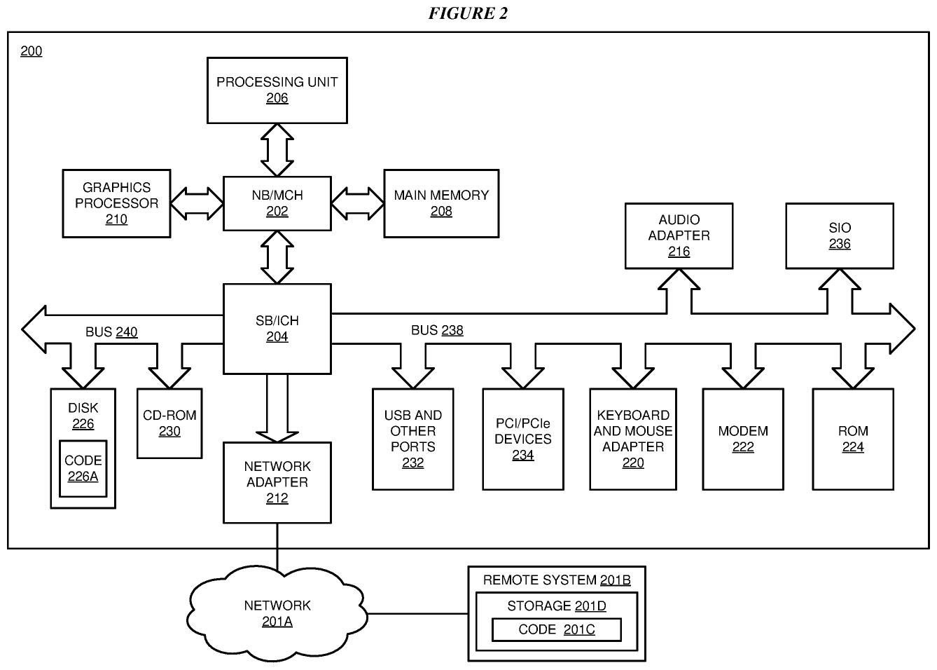

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown. Server 104 includes an application 105 that may be configured to implement one or more of the functions described herein for adversarial input identification using reduced precision deep neural networks in accordance with one or more embodiments. Server 104 further includes one or more deep neural network (DNN) models 107 in accordance with one or more embodiments.

Storage device 108 includes neural network training data 109 configured to store training data for training the one or more DNN models 107 as described herein.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as device 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

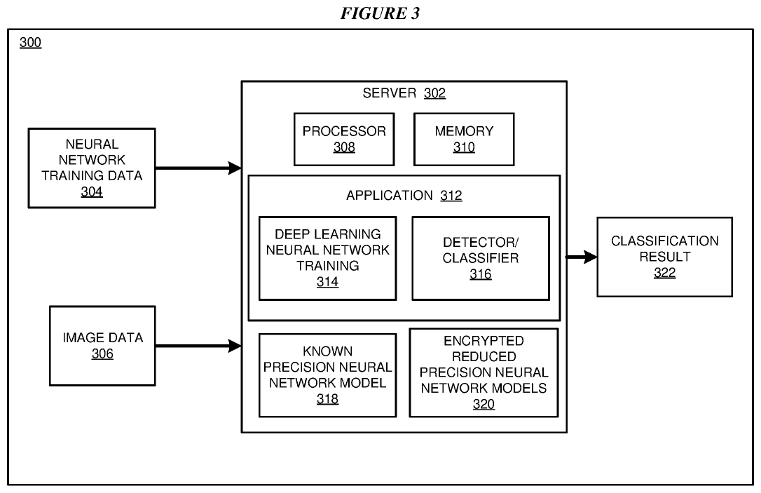

With reference to FIG. 3, this figure depicts a block diagram of an example configuration 300 for adversarial input identification using reduced precision deep neural networks in accordance with an illustrative embodiment. The example embodiment includes a server 302. In a particular embodiment, server 302 is an example of server 104 of FIG. 1.

Server 302 is configured to received neural network training data 304 and input image data 306 as further described herein with respect to one or more embodiments. Server 302 includes a processor 308, a memory 310, and an application 312. Processor 308 is configured to retrieve instructions and data from memory 310 to perform various functions of server 302 as described herein. In a particular embodiment, application 312 is an example of application 105 of FIG. 1. Application 312 includes a deep learning neural network training component 314 and a detector/classifier component 316. Server 302 further includes a known precision neural network model 318 and one or more encrypted reduced precision neural network models 320.

In one or more embodiments, deep learning neural network training component 314 is configured to receive neural network training data 304 and train known precision neural network model 318 and the one or more encrypted reduced precision neural network models 320 using neural network training data 304. In one or more embodiments, neural network training data 304 includes image data and associated image classifications of training images. In one or more embodiments, known precision neural network model 318 is a neural network model having model parameters, such as a numerical precision level, that are known to one or more users. In particular embodiments, known precision neural network model 318 is a published neural network model with a known numerical precision level such as a full 16-bit or 32-bit numerical precision level.

In one or more embodiments, encrypted reduced precision neural network models 320 include one or more reduced precision neural network models that are encrypted in a manner such that the model parameters, such as numerical precision level, are not known to the user. In one or more embodiments, each of the one or more encrypted reduced precision neural network models 320 has an associated numerical precision level that is different from the other encrypted reduced precision neural network models 320. In a particular embodiment, encrypted reduced precision neural network models 320 are implemented using one or more application-specific integrated circuits (ASICs) having processing elements of configurable precision allowing for different precisions in different layers, different parallelisms, different data formats, and/or different chunking of data. In particular embodiments, a deep learning ASIC is configured to hide different precision models of a neural network from users.

In one or more embodiments, encrypted reduced precision neural network models 320 may be configured with different numerical precision formats including different numerical data types (e.g., integer or floating point), different numerical lengths, different numerical precision levels in different neural network layers, and/or different numerical precision levels within the same neural network layer.

In one or more embodiments, application 312 is configured to received image data 306 and provide image data 306 to known precision neural network 318 and the one or more encrypted reduced precision neural network models 320. Each of known precision neural network 318 and the one or more encrypted reduced precision neural network models 320 is configured to process image data 306 and output a feature vector corresponding to image data 306.

In one or more embodiments, detector/classifier component 316 is configured to compute a similarity measure between the feature vectors corresponding to each of known precision neural network 318 and the one or more encrypted reduced precision neural network models 320, and determine whether the similarity metric is within a predetermined threshold value. In one or more embodiments, if the similarity metric is within the predetermined threshold value, detector/classifier 316 determines a classification of an image represented by image data 306 and outputs a classification result 322 corresponding to the classification. In one or more embodiments, if the similarity metric is not within the predetermined threshold value, detector/classifier 316 determines that image data 306 contains adversarial data, outputs classification result 322 indicative of input data 306 including the adversarial data. In one or more embodiments, application 312 may be configured to discard or filter out image data 306 that is determined to contain adversarial data.

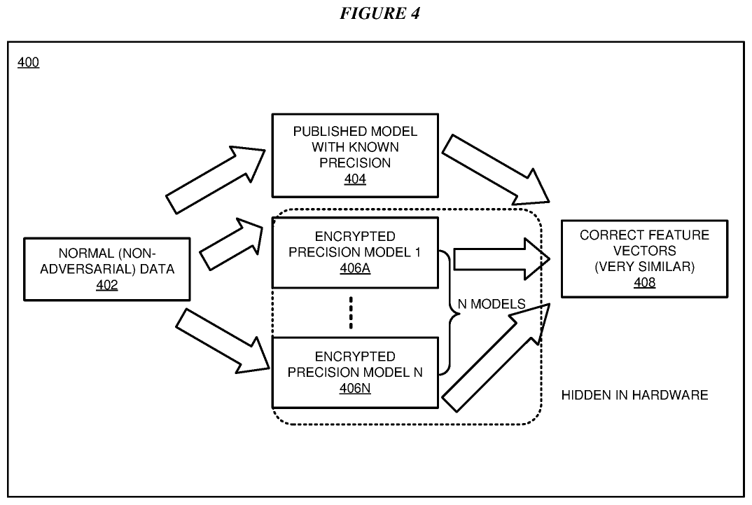

With reference to FIG. 4, this figure depicts a block diagram of an example sequence 400 for classification of normal non-adversarial data using reduced numerical precision neural networks in accordance with an illustrative embodiment. In one or more embodiments, training architecture 400 is implemented by application 105 and deep neural network models 107 of FIG. 1.

In the embodiment, normal (non-adversarial) data 402 is processed by each of a published neural network model with known numerical precision 404 and a plurality of encrypted reduced precision models 406A-406N. In the embodiment of FIG. 4, published neural network model 404 is a full numerical precision (e.g., 16 bit or 32 bit floating point) neural network model having neural network parameters that are known to users from published sources. In the embodiment, each of the plurality of encrypted reduced precision models 406A-406N has a numerical precision level that is less than that of published neural network model 404. In the embodiment, each of the plurality of encrypted reduced precision models 406A-406N are hidden in hardware encryption. In particular embodiments, each of the plurality of encrypted reduced precision models 406A-406N may have differing overall numerical precision levels from one another and/or different numerical precision levels within one or more neural network layers. In one or more embodiments, each of published neural network model 404 and the plurality of encrypted reduced precision models 406A-406N includes a DNN.

In the embodiment, each of published neural network model 404 and the plurality of encrypted reduced precision models 406A-406N computes one or more feature vectors corresponding to normal data 402 in parallel. In the embodiment, application 105 computes a similarity metric between the feature vectors. Since normal data 402 does not contain adversarial data, the features vectors generated by encrypted reduced precision models 406A-406N are very similar in comparison to one another and the feature vectors generated by the full precision published neural network model 404 resulting in correct feature vectors 408. Accordingly, the sequence 400 results in a valid classification of normal data 402.

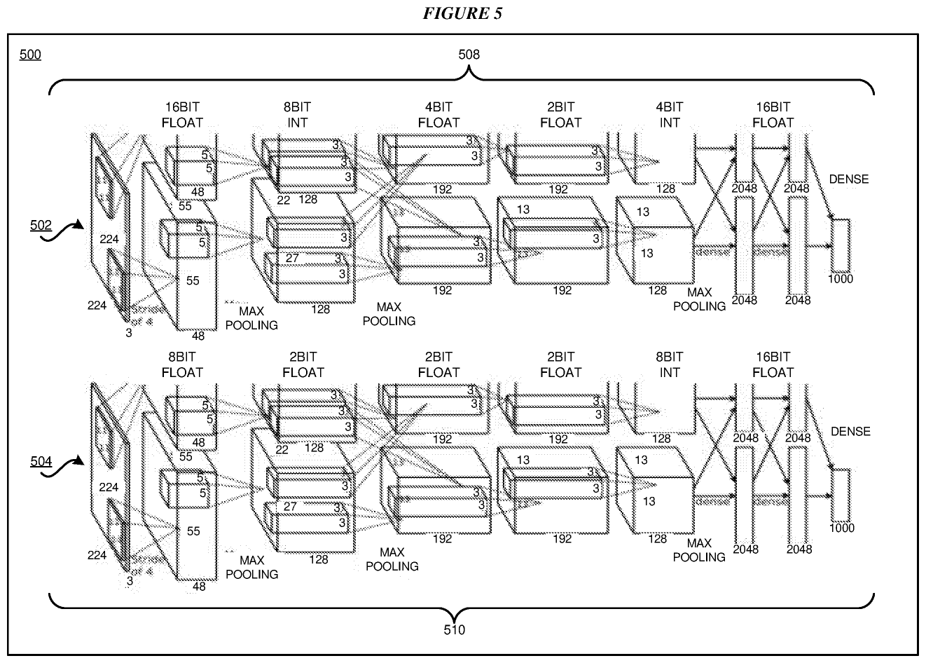

With reference to FIG. 5, this figure depicts a block diagram of an example architecture 500 for encrypted reduced precision neural network models in accordance with an embodiment. Example architecture 500 includes a first encrypted reduced precision neural network model 502 and a second encrypted reduced precision neural network model 504. First encrypted reduced precision neural network model 502 includes a first plurality of neural network layers 508. In the particular example of FIG. 5, the first plurality of neural network layers 508 includes a 16-bit floating point precision layer, an 8-bit integer precision layer, a 4-bit floating point precision layer, a 2-bit floating point precision layer, a 4-bit integer precision layer, and a 16-bit floating point precision layer.

Second encrypted reduced precision neural network model 502 includes a second plurality of neural network layers 510. In the particular example of FIG. 5, the second plurality of neural network layers 510 includes an 8-bit floating point precision layer, three 2-bit floating point precision layers, an 8-bit integer precision layer, and a 16-bit floating point precision layer.

Providing the same input image data to first encrypted reduced precision neural network model 502 and second encrypted reduced precision neural network model 504 results in feature vectors that are substantially different from one another when the input image data includes adversarial data. Accordingly, the different precision and a data representations of first encrypted reduced precision neural network model 502 and second encrypted reduced precision neural network model 504 make adversarial attack extremely difficult.

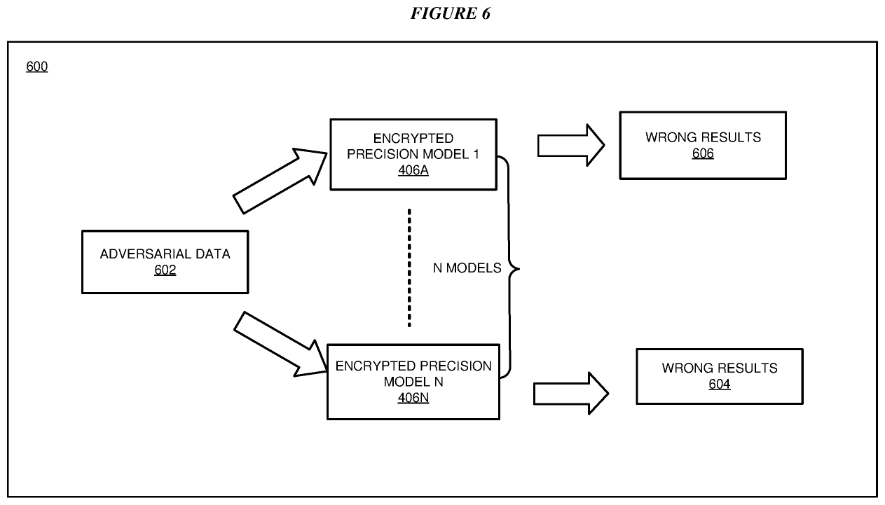

With reference to FIG. 6, this figure depicts a block diagram of an example sequence 600 for identification of adversarial data using reduced numerical precision neural networks in accordance with an illustrative embodiment. In the embodiment, adversarial data 602 is processed by each of encrypted reduced precision models 406A-406N in parallel to generate feature vectors. In the example of FIG. 6, when encrypted reduced precision models 406A-406N process adversarial data 602, very different feature vectors are generated than that generated by a full numerical precision neural network model resulting in a first set of wrong results 604 and/or a second set of wrong results 606 in which the second set of wrong results 606 has a greater degree of incorrectness than the first set of wrong results 604. Through differences in the feature vectors between a full numerical precision neural network model and one or more reduced numerical precision neural network models, between feature vectors of the one or more reduced numerical precision neural network models, or a combination thereof, the system can identify that adversarial data 602 contains data that is adversarial and likely a result of an attempted adversarial attack.

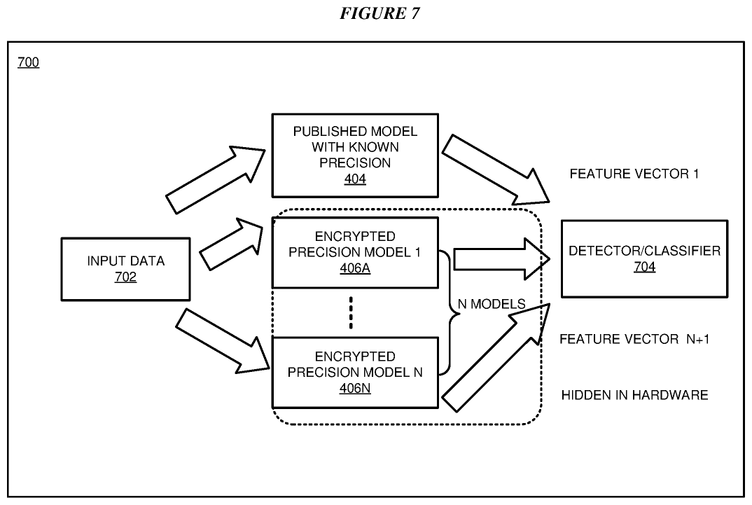

With reference to FIG. 7, this figure depicts a block diagram of an example detector/classifier architecture 700 for adversarial input identification using reduced precision deep neural networks in accordance with an illustrative embodiment. In one or more embodiments, training architecture 700 is implemented by application 105 and deep neural network models 107 of FIG. 1.

In the embodiment, input data 702 is processed by each of published neural network model 404 and the plurality of encrypted reduced precision models 406A-406N to generate feature vectors 1-N. In a particular embodiment, input data 702 contains image data. In the embodiment of FIG. 7, published neural network model 404 is a full numerical precision (e.g., 16 bit or 32 bit floating point) neural network model having neural network parameters that are known to users from published sources, and each of the plurality of encrypted reduced precision models 406A-406N has a numerical precision level that is less than that of published neural network model 404. In the embodiment, each of the plurality of encrypted reduced precision models 406A-406N are hidden in hardware encryption. In particular embodiments, each of the plurality of encrypted reduced precision models 406A-406N may have differing overall numerical precision levels from one another and/or different numerical precision levels within one or more neural network layers. In one or more embodiments, each of published neural network model 404 and the plurality of encrypted reduced precision models 406A-406N includes a DNN.

In the embodiment, detector/classifier 105 computes a similarity metric between the feature vectors of published neural network model 404 and the plurality of encrypted reduced precision models 406A-406N as described herein with respect to one or more embodiments. If the similarity metric of the feature vectors indicates that the feature vectors are similar to one another within a predetermined similarity threshold value, detector/classifier 704 determines that input data 702 is normal data without containing adversarial data and outputs a classification of the input data 702 based upon the feature vectors.

However, if the similarity metric of the feature vectors indicates that the feature vectors are not similar to one another within the predetermined similarity threshold value, detector/classifier 704 determines that input data 702 contains adversarial data, and detector/classifier 704 filters out or discards input data 702.

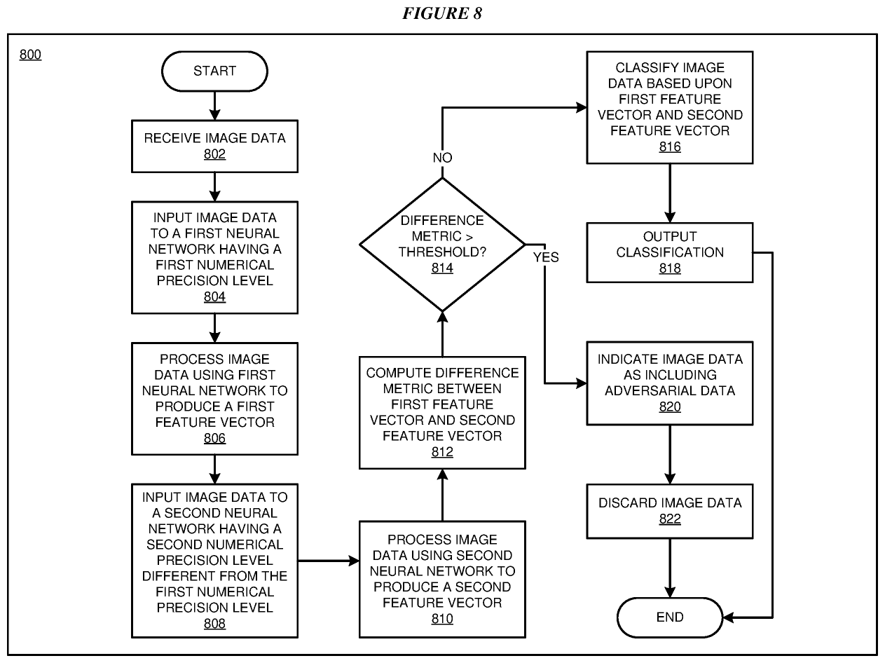

With reference to FIG. 8, this figure depicts a flowchart of an example process 800 for adversarial input identification using reduced precision deep neural networks in accordance with an illustrative embodiment. In one or more embodiments, example process 800 may be implemented by one or more of application 105 and deep neural network models 107 of FIG. 1.

In block 802, application 105 receives image data. In block 804, application 105 inputs the image data to a first neural network including a first neural network model having a first numerical precision level. In a particular embodiment, the first numerical precision level is a full numerical precision level. In a particular embodiment, the first neural network model having model parameters, such as a numerical precision level, that are known to one or more users. In particular embodiments, first neural network model is a published neural network model with a known numerical precision level such as a full 16-bit or 32-bit numerical precision level. In another embodiment, the first neural network model is a reduced precision neural network model. In another particular embodiment, the first neural network model is an encrypted neural network model. In block 806, application 105 processes the image data using the first neural network to produce a first feature vector from the image data.

In block 808, application 105 inputs the image data to a second neural network including a second neural network model having a second numerical precision level different from the first numerical precision level. In a particular embodiment, the second neural network model is a reduced precision neural network model in which the second numerical precision level is less than the first numerical precision level. In another particular embodiment, the second neural network model is an encrypted neural network model. In a particular embodiment, one or more layers of the second neural network model include different numerical precision levels. In another particular embodiment, one or more layers of the second neural network are configured with different numerical precision formats. In another particular embodiment, the different numerical formats include different numerical data types. In one or more embodiments, one or more of the first neural network and the second neural network includes a DNN.

In block 810, application 105 processes the image data using the second neural network to produce a second feature vector from the image data. In block 812, application 105 computes a difference metric between the first feature vector and the second feature vector. In block 814, application 105 determines whether the difference metric is greater than a predetermined threshold value.

If application 105 determines that the difference metric is not greater than the predetermined threshold, in block 816 application 105 classifies the image data based upon the first feature vector and the second feature vector and process 800 continues to block 818. In block 818, application 105 outputs the classification of the image data and process 800 ends.

If application 105 determines that the difference metric is greater than the predetermined threshold, in block 820 application 105 indicates that the image data include adversarial data and process 800 continues to block 822. In block 822, application 105 discards the image data indicated as including the adversarial data and process 800 ends.

Thus, a computer implemented method, system or apparatus, and computer program product are provided in the illustrative embodiments for adversarial input identification using reduced precision deep neural networks and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
receiving, by a processor, input data;
providing the input data to a first neural network including a first neural network model, the first neural network model having a first numerical precision level;
generating a first feature vector from the input data using the first neural network;
providing the input data to a second neural network including a second neural network model, the second neural network model having a second numerical precision level different from the first numerical precession level;
generating a second feature vector from the input data using the second neural network; and
computing a difference metric between the first feature vector and the second feature vector, the difference metric indicative of whether the input data includes adversarial data.

2. The method of claim 1, further comprising:
comparing the difference metric to a predetermined threshold value.

3. The method of claim 2, further comprising:
determining that the difference metric exceeds the predetermined threshold value; and
determining that the input data includes the adversarial data responsive to the determining that the difference metric exceeds the predetermined threshold value.

4. The method of claim 3, further comprising:
discarding the input data.

5. The method of claim 2, further comprising:
determining that the difference metric does not exceed the predetermined threshold value; and
determining a classification of the input data responsive to the determining that the difference metric does not exceed the predetermined threshold value.

6. The method of claim 1, wherein the first numerical precision level is greater than the second numerical precision level.

7. The method of claim 1, wherein the first numerical precision level is a full numerical precision level.

8. The method of claim 1, wherein the first neural network model is a published neural network model with a known numerical precision level.

9. The method of claim 1, wherein the second neural network model is a reduced precision neural network model.

10. The method of claim 1, wherein the second neural network model is an encrypted neural network model.

11. The method of claim 1, wherein one or more layers of the second neural network model include different numerical precision levels.

12. The method of claim 1, wherein one or more of the first neural network or the second neural network includes a deep neural network (DNN).

13. The method of claim 1, wherein the input data includes image data.

14. A computer usable program product comprising one or more computer-readable storage devices, and program instructions stored on at least one of the one or more storage devices, the stored program instructions comprising:
program instructions to receive, by a processor, input data;
program instructions to provide the input data to a first neural network including a first neural network model, the first neural network model having a first numerical precision level;
program instructions to generate a first feature vector from the input data using the first neural network;
program instructions to provide the input data to a second neural network including a second neural network model, the second neural network model having a second numerical precision level different from the first numerical precession level;
program instructions to generate a second feature vector from the input data using the second neural network; and
program instructions to compute a difference metric between the first feature vector and the second feature vector, the difference metric indicative of whether the input data includes adversarial data.

15. The computer usable program product of claim 14, further comprising:
program instructions to compare the difference metric to a predetermined threshold value.

16. The computer usable program product of claim 15, further comprising:
program instructions to determine that the difference metric exceeds the predetermined threshold value; and
program instructions to determine that the input data includes the adversarial data responsive to determining that the difference metric exceeds the predetermined threshold value.

17. The computer usable program product of claim 16, further comprising:
program instructions to discard the input data.

18. The computer usable program product of claim 14, wherein the computer usable code is stored in a computer readable storage device in a data processing system, and wherein the computer usable code is transferred over a network from a remote data processing system.

19. The computer usable program product of claim 14, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to receive, by a processor, input data;
program instructions to provide the input data to a first neural network including a first neural network model, the first neural network model having a first numerical precision level;
program instructions to generate a first feature vector from the input data using the first neural network;
program instructions to provide the input data to a second neural network including a second neural network model, the second neural network model having a second numerical precision level different from the first numerical precession level;
program instructions to generate a second feature vector from the input data using the second neural network; and
program instructions to compute a difference metric between the first feature vector and the second feature vector, the difference metric indicative of whether the input data includes adversarial data.
